(19) United States
(12) Patent Application Publication
(10) Pub. No.: US 2020/0250552 A1
(43) Pub. Date: Aug. 6, 2020

(54) DIAGNOSIS MODEL COMPONENT REUSE SUPPORT APPARATUS AND DIAGNOSIS MODEL COMPONENT REUSE SUPPORT METHOD

(71) Applicant: Hitachi, Ltd., Tokyo (JP)

(72) Inventors: Kyoko ISHIDA, Tokyo (JP); Hideaki SUZUKI, Tokyo (JP)

(21) Appl. No.: 16/652,093

(22) PCT Filed: Oct. 20, 2017
(86) PCT No.: PCT/JP2017/037988

§ 371 Date: Mar. 30, 2020

(51) Int. Cl. G06N 5/04; G06N 20/00

(52) U.S. Cl. CPC G06N 5/04; G06N 20/00

(57) ABSTRACT

A diagnosis model component reuse support apparatus includes a case characteristic storage part, a diagnosis model storage part, a diagnosis module storage part, and an operational device that supports reuse of a diagnosis model component of a past diagnosis case when a diagnosis model for a new diagnosis case is constructed. The operational device includes a reusability calculator that, by using case characteristics in the case characteristic storage part, a diagnosis model in the diagnosis model storage part, and diagnosis modules in the diagnosis module storage part, calculates, for each of the case characteristics, the reusability of each of the diagnosis modules or the reusability of a coupling relationship of the diagnosis modules, and extracts a diagnosis module or a coupling relationship having high reusability as a diagnosis model component. The operational device also includes a coupling relationship extension part that adds another diagnosis module to the diagnosis model component.

### TECHNICAL FIELD

The present invention relates to a diagnosis model component reuse support apparatus and a diagnosis model component reuse support method for supporting the reuse of a diagnosis model component of a past diagnosis case at the time of constructing a diagnosis model of a new diagnosis case to be used in an equipment diagnosis system.

### BACKGROUND ART

The equipment diagnosis system detects an abnormality sign of equipment to be diagnosed and estimates a failure cause of the equipment to be diagnosed based on signal data from a sensor installed in the equipment to be diagnosed, to provide a customer engineer with information on the detection of the abnormality sign and the estimation of the failure cause.

In this type of diagnosis, it is necessary to define a diagnosis model for analyzing signal data for each piece of equipment to be diagnosed and each event to be diagnosed. For example, when an abnormality sign or the like is wanted to be detected based on the vibration of the equipment to be diagnosed, signal data of a vibration sensor installed in normal equipment to be diagnosed is collected in advance, frequency analysis using a low-pass filter or fast Fourier transform (FFT) is performed, and then, a cluster related to a frequency band in a normal state is generated by a machine learning method such as K-means. At the time of diagnosis, the same frequency analysis is performed on signal data of a vibration sensor installed in the equipment to be diagnosed, and a comparison with the cluster in the normal state is made to diagnose the abnormality. For improving the diagnosis accuracy of the equipment diagnosis system, it is important to develop an appropriate diagnosis model in accordance with the equipment to be diagnosed so as to prevent erroneous diagnosis (an abnormality is detected by the equipment diagnosis system despite the fact that all pieces of equipment to be diagnosed and sensors are normal) and non-detection (an abnormality is not detected by the equipment diagnosis system despite the fact that the equipment to be diagnosed or sensor is abnormal).

Meanwhile, the number of pieces of equipment to be diagnosed and the scale of equipment to be diagnosed are increasing with the expansion of the application range of the equipment diagnosis system. Thus, in recent years, there has been a demand for significant improvement in development efficiency for a diagnosis model suited to new equipment to be diagnosed, and as one method therefor, it has been proposed to improve the efficiency by reusing a diagnosis model developed in the past.

As a conventional technique for supporting the reuse of software components, for example, there is a technique described in PTL 1. The abstract of this literature states, “A likelihood indicating the distribution of the frequency of each specification of existing equipment is calculated for each version of software components used in control software for the existing equipment, and a prior probability indicating the distribution of the use frequency of each version is calculated for each software component used in the control software for the existing equipment. A posterior probability indicating the reusability of each version of the existing software components is calculated for each specification of equipment to be developed, based on the likelihood and the prior probability”.

Further, as a conventional technique for improving the efficiency of software maintenance, for example, there is a technique described in NPL 1. This literature describes a technique for extracting a combination of functions that are frequently modified simultaneously in the same version when a programmer modifies a software function in a plurality of times.

### CITATION LIST

### Patent Literature

PTL 1: JP 2010-250739 A

### Non-Patent Literature

NPL 1: T Zimmermann, A Zeller, P Weissgerber, and S Diehl: “Mining Version Histories to Guide Software Changes,” IEEE Transactions on Software Engineering 31 (6), 429-445 (2005)

### SUMMARY OF INVENTION

### Technical Problem

PTL 1 calculates the reusability of each software component in accordance with the specification of the equipment but does not consider the reusability regarding a coupling relationship (call sequence) of a plurality of software components. Further, since the reusability of each of all software components is calculated irrespective of the equipment specification, there is a possibility that a software component irrelevant to the equipment specification is erroneously determined to be highly reusable.

NPL 1 extracts a combination of functions that are frequently modified simultaneously in the same version of software, but does not consider a purpose of modification of each function when extracting the combination. Therefore, even when a plurality of functions are simultaneously modified in response to a plurality of modification purposes, a function corresponding to a predetermined modification purpose cannot be specified, and an originally unrelated function modified for a purpose different from the programmer's modification purpose may be extracted as a function that requires simultaneous modification.

Therefore, an object of the present invention is to provide a diagnosis model component reuse support apparatus and a diagnosis model component reuse support method capable of evaluating a coupling relationship (call sequence) of a plurality of diagnosis modules (units of processing constituting a diagnosis model) included in a past diagnosis model for each characteristic of a diagnosis case, and appropriately extracting a reusable diagnosis model component to be proposed to a user who intends to develop a new diagnosis model.

### Solution to Problem

In order to solve the above problems, a diagnosis model component reuse support apparatus includes: a case characteristic storage part that stores case characteristics of a past diagnosis case; a diagnosis model storage part that stores a diagnosis model of the past diagnosis case; a diagnosis module storage part that stores diagnosis modules constituting the diagnosis model; and an operational device that supports reuse of a diagnosis model component of the past diagnosis case when a diagnosis model for a new diagnosis case is constructed. The operational device includes a reusability calculator that, by using the case characteristics in the case characteristic storage part, the diagnosis model in the diagnosis model storage part, and the diagnosis modules in the diagnosis module storage part, calculates, for each of the case characteristics, reusability of each of the diagnosis modules or reusability of a coupling relationship of the diagnosis modules, and selects a diagnosis module or a coupling relationship having high reusability as a diagnosis model component. The operational device also includes a coupling relationship extension part that extends the coupling relationship by adding another diagnosis module to the diagnosis model component.

A diagnosis model component reuse support method is for supporting reuse of a diagnosis model component of a past diagnosis case by using case characteristics of a past diagnosis case, a diagnosis model of the past diagnosis case, and diagnosis modules each of which is a unit of processing of the diagnosis model when a diagnosis model for a new diagnosis case is constructed. The method includes: calculating, by using the past case characteristics, the past diagnosis model, and the past diagnosis modules, reusability of each of the diagnosis modules or reusability of a coupling relationship of the diagnosis modules for each of the case characteristics, and selecting a diagnosis module or a coupling relationship having high reusability as a diagnosis model component; and subsequently extending the coupling relationship by adding another diagnosis module to the diagnosis model component.

### Advantageous Effects of Invention

According to the present invention, it is possible to evaluate information of the coupling of a plurality of diagnosis modules for each characteristic of a diagnosis case and extract the information as a reusable diagnosis model component. Thereby, a diagnosis model component having high reusability based on a past diagnosis model can be proposed to a user who intends to develop a new diagnosis model, so that the development efficiency for the new diagnosis model can be improved.

### BRIEF DESCRIPTION OF DRAWINGS

FIG. 1 is a functional block diagram of a diagnosis model component reuse support apparatus according to one embodiment.

FIG. 2 is an example of a hardware configuration of the diagnosis model component reuse support apparatus in FIG. 1.

FIG. 3 is a flowchart illustrating an example of diagnosis model component generation processing.

FIG. 4 is an example of a case characteristic table.

FIG. 5 is an example of a diagnosis module table.

FIG. 6 is an example of a case characteristic category/diagnosis module category relationship table.

FIG. 7 is an example of a diagnosis model component table.

FIG. 8 is a flowchart illustrating an example of search/presentation processing.

FIG. 9 is an example of a screen display for receiving inputs of case characteristics from a user.

FIG. 10 is an example of a screen display for suggesting a diagnosis model component to the user.

### DESCRIPTION OF EMBODIMENTS

Hereinafter, an embodiment of the present invention will be described with reference to the drawings. In the following, although supplementary descriptions will be given for details as appropriate, “case characteristics” are characteristics that should be considered at the time of developing a diagnosis model, such as a data format, a data/sensor type, and a diagnosis purpose, a “diagnosis model” is information that defines the sequence of all processing necessary for diagnosing a diagnosis case, a “diagnosis module” is a unit of processing that constitutes a diagnosis model, and a “diagnosis model component” is information indicating a single diagnosis module which is a part of the diagnosis model or a combination sequence of diagnosis modules.

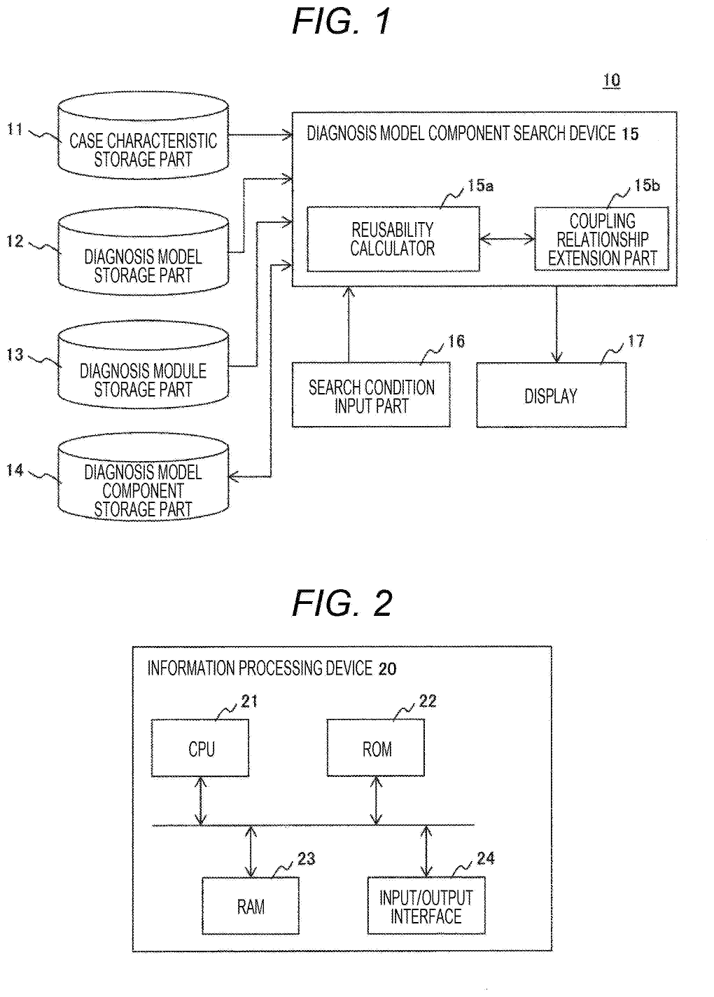

FIG. 1 is a functional block diagram of a diagnosis model component reuse support apparatus according to one embodiment. As illustrated here, a diagnosis model component reuse support apparatus 10 includes a case characteristic storage part 11, a diagnosis model storage part 12, a diagnosis module storage part 13, a diagnosis model component storage part 14, a diagnosis model component search device 15, a search condition input part 16, and a display 17. Further, the diagnosis model component search device 15 includes a reusability calculator 15a and a coupling relationship extension part 15b.

FIG. 2 is a diagram illustrating an example of a hardware configuration for achieving the diagnosis model component reuse support apparatus 10. Some of functional blocks (the diagnosis model component search device 15, etc.) in the diagnosis model component reuse support apparatus 10 are achieved by an information processing device 20 that operates in accordance with a program. The information processing device 20 includes a central processing unit (CPU) 21, a read-only memory (ROM) 22, a random-access memory (RAM) 23, and an input/output interface 24. The CPU 21 reads out programs stored in the ROM 22 and the RAM 23 and operates based on the read-out programs to perform control as each functional block. Further, the ROM 22 stores a boot program achieved by 21 when the information processing device 20 is started, a program depending on hardware of the information processing device 20, and the like. The RAM 23 stores programs to be executed by the CPU 21, data to be used by the CPU 21, and the like. Each functional block is constructed by executing a predetermined program read by the CPU 21. The CPU 21 controls input/output devices such as a keyboard, a mouse, and a display (liquid crystal display (LCD)) via the input/output interface 24. The CPU 21 acquires data from the keyboard, the mouse, or the like via the input/output interface 24.

Note that the input/output interface 24 mentioned here may be except for the display, the keyboard, and the mouse. For example, the input/output interface 24 may be a tablet terminal or a smart device having a display function and a touch panel function. In such a case, the information procedure device 20 may include the CPU 21, the ROM 22, and the RAM 23, and the input/output interface 24 may be a terminal connected by wire or wirelessly.

The hardware configuration that achieves each functional block in the diagnosis model component reuse support apparatus 10 is based on the configuration of the information processing device 20 as described above, and employs an appropriate configuration depending on a function to be achieved.

Returning to FIG. 1, each functional block will be described. The case characteristic storage part 11 is a storage part that accumulates case characteristics of a past diagnosis case. The diagnosis model storage part 12 is a storage part that accumulates a diagnosis model used in the diagnosis case with its case characteristics stored in the case characteristic storage part 11. The diagnosis module storage part 13 is a storage part that accumulates diagnosis modules constituting the diagnosis model stored in the diagnosis model storage part 12. The diagnosis model component storage part 14 is a storage part that stores diagnosis model component searched by the diagnosis model component search device 15. In FIG. 1, the four storage parts (11 to 14) are displayed as independent databases, but these four storage parts may be stored in a common storage medium.

The diagnosis model component search device 15 is a functional part that searches a reusable diagnosis model component (a coupling relationship of diagnosis modules) from the diagnosis model stored in the diagnosis model storage part 12, for each of the case characteristics stored in the case characteristic storage part 11 The reusability calculator 15a is a functional part that calculates the reusability of a single diagnosis module or the coupling relationship. The coupling relationship extension part 15b is a functional part that extends the coupling relationship by adding another diagnosis module to the single diagnosis module or the coupling relationship, the reusability of which has been calculated in the reusability calculator 15a.

The search condition input part 16 is a functional part that receives, via the input/output interface 24 of FIG. 2, case characteristics of a new diagnosis case input by a user. The display 17 is a functional part that presents a reusable diagnosis model component to a user via the input/output interface 24 of FIG. 2.

Next, processing executed in the present embodiment will be described. The operation of the diagnosis model component reuse support apparatus 10 has two phases: “diagnosis model component generation” processing of generating a diagnosis model component in advance for each case characteristic; and “search/presentation” processing of presenting a diagnosis model component in accordance with case characteristics input by the user.

<“Diagnosis Model Component Generation” Processing>

First, the “diagnosis model component generation” processing, which is a first phase of the operation of the diagnosis model component reuse support apparatus 10, will be described.

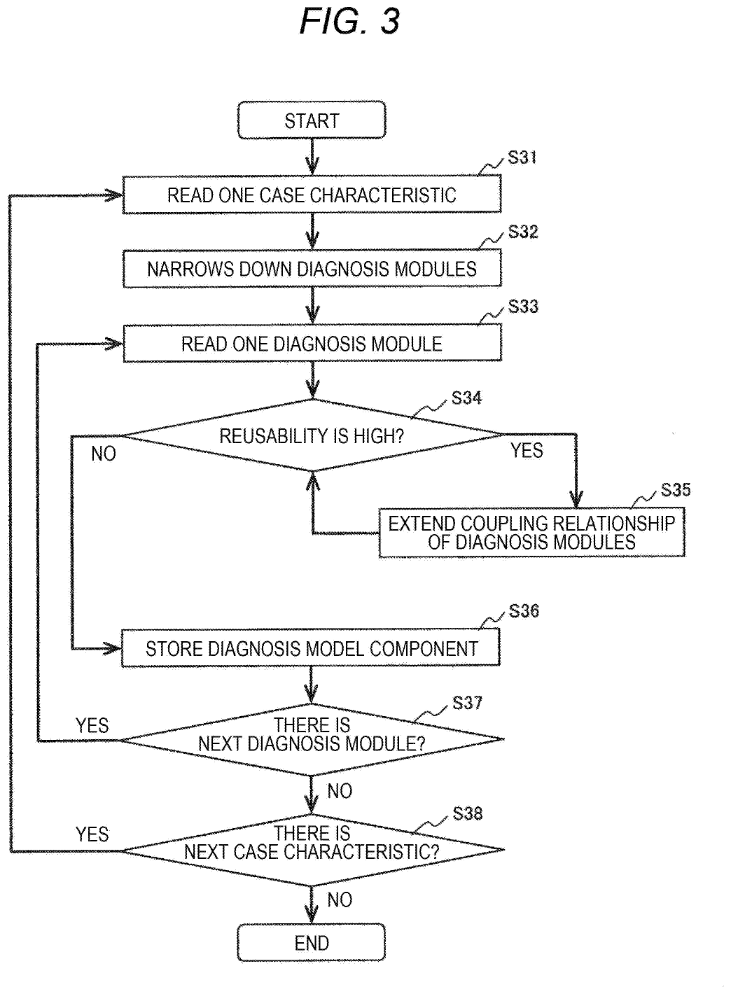

FIG. 3 is a flowchart illustrating diagnosis model component generation processing that is executed by the diagnosis model component reuse support apparatus 10. This processing is started by the diagnosis model component reuse support apparatus 10 receiving from the user an instruction to execute the diagnosis model component generation processing, but a program that periodically executes the component generation processing may be set in advance.

When the diagnosis model component generation processing is started, the diagnosis model component search device 15 reads one case characteristic stored in the case characteristic storage part 11 (step 31).

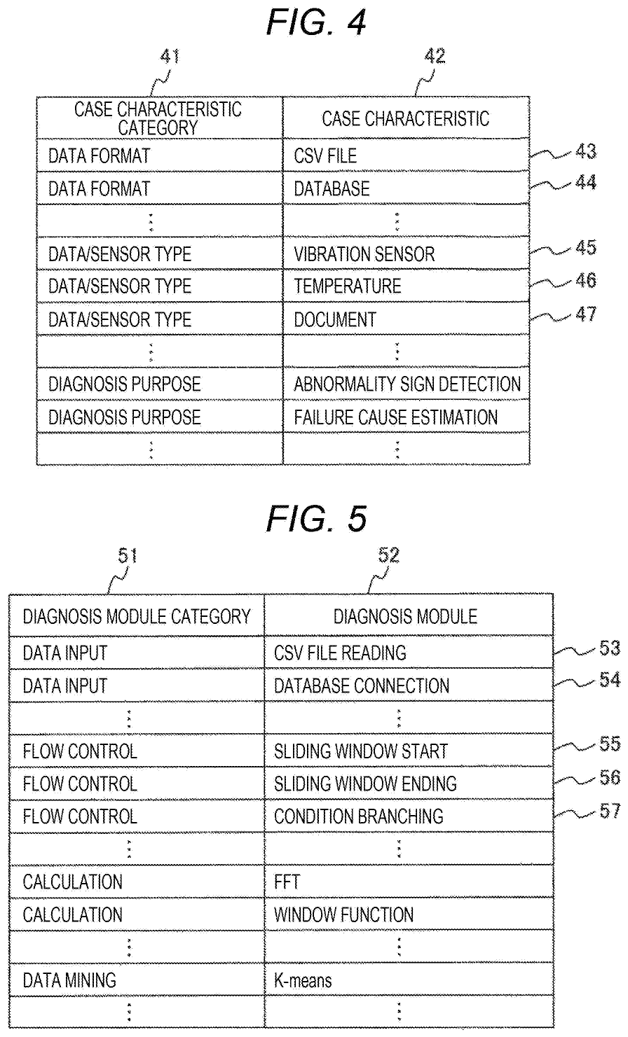

FIG. 4 is an example of a case characteristic table stored in the case characteristic storage part 11. In this table, a case characteristic category field 41 is a field for storing a category of a case characteristic stored in a case characteristic field 42, and the case characteristic field 42 is a field for storing a case characteristic of a diagnosis case for which a diagnosis model is componentized in the diagnosis model component reuse support apparatus 10.

For example, “CSV file (record 43)” and “database (record 44)” are registered as case characteristics corresponding to a case characteristic category “data format,” and “vibration sensor (record 45),” “temperature (record 46),” and “document (record 47)” are registered as case characteristics corresponding to a case characteristic category “data/sensor type.”

Hereinafter, a description will be given on the assumption that record 45 (case characteristic category “data/sensor type,” case characteristic “vibration sensor”) is selected in step 31.

When one case characteristic (e.g., record 45) is selected in step 31, next, the diagnosis model component search device 15 narrows diagnosis modules down to those associated with case characteristics by using the read case characteristics and the information of the diagnosis modules accumulated in the diagnosis module storage part 13 (step 32).

FIG. 5 is an example of a diagnosis module table stored in the diagnosis module storage part 13. In this table, a diagnosis category field 51 is a field for storing a category of a diagnosis module stored in the diagnosis module field 52, and a diagnosis module field 52 is a field for storing a module constituting a diagnosis model in the diagnosis model component reuse support apparatus 10. Here, the diagnosis model is configured by the coupling relationship (sequential call) of the diagnosis modules described in the diagnosis module field 52.

For example, “CSV file reading (record 53)” and “database connection (record 54)” are registered as diagnosis modules corresponding to a diagnosis module category “data input,” and “sliding window start (record 55),” “sliding window ending (record 56),” and “condition branching (record 57)” are registered as diagnosis modules corresponding to a diagnosis module category “flow control.”

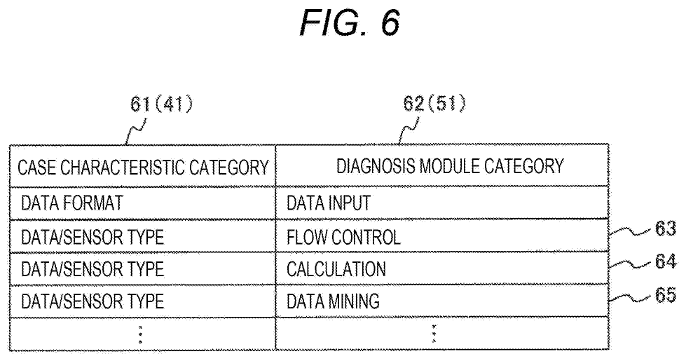

FIG. 6 is an example of a case characteristic category/diagnosis module category relationship table stored in the diagnosis module storage part 13. In this table, a case characteristic category field 61 is a field for storing the same contents as those of the case characteristic category field 41, and a diagnosis module category field 62 is a field for storing the contents of the diagnosis module category field 51.

For example, “flow control (record 63),” “calculation (record 64),” and “data mining (record 65)” are registered as diagnosis module categories corresponding to the case characteristic category “data/sensor type.”

When record 45 (case characteristic category “data/sensor type,” case characteristic “vibration sensor”) is selected in step 31, “flow control (record 63),” “calculation (record 64),” and “data mining (record 65)” are extracted as diagnosis module categories corresponding to the case characteristic category “data/sensor type” with reference to the table of FIG. 6. Further, with reference to the table of FIG. 5, “sliding window start (record 55),” “sliding window ending (record 56),” and “condition branching (record 57)”, which are diagnosis modules corresponding to the diagnosis module category “flow control” are extracted, and diagnosis modules (FFT, window function, K-means, etc.) corresponding to the diagnosis module categories “calculation” and “data mining” are also extracted.

In step 32 described above, the diagnosis modules are narrowed down to those corresponding to the one case characteristic selected in step 31, so that a diagnosis module that is not necessary for the diagnosis of the case characteristic “vibration sensor,” such as “CSV file reading,” is made not subject to componentization.

After narrowing the diagnosis modules down to those corresponding to the selected case characteristic, the diagnosis model component search device 15 next reads one diagnosis module among the narrowed-down diagnosis modules (e.g., “sliding window start (record 55)”) (step 33).

Subsequently, the reusability calculator 15a verifies the reusability of the diagnosis module read in step 33 with respect to the diagnosis model of the diagnosis case of the case characteristic read in step 31 (step 34). This reusability is performed, for example, by extracting the diagnosis model of the diagnosis case of the case characteristic “vibration sensor (record 45)” from the past diagnosis model stored in the diagnosis model storage part 12, and calculating the use frequency of the diagnosis module “sliding window start (record 55).” When the calculated use frequency exceeds a preset threshold (e.g., 80%), it is determined that the reusability is high. In the verification of the reusability in step 34, the verification may be performed based on the use frequency as described in the example, or the extraction may be performed regardless of the use frequency by using a method such as Bayesian inference.

When it is determined in step 34 that the reusability is high for the selected diagnosis module, the coupling relationship extension part 15b extends the coupling relationship of the diagnosis modules with high reusability (step 35). For example, a diagnosis model corresponding to the case characteristic “vibration sensor” is extracted from the diagnosis model storage part 12, and from here, a case where another diagnosis module is coupled to the diagnosis module “sliding window start” is searched. Then, for example, when a case where the diagnosis module “window function” is coupled to the diagnosis module “sliding window start” can be extracted, the reusability of the coupling relationship combining “sliding window start” and “window function” is verified (step 34). Specifically, the diagnosis model of the diagnosis case of the case characteristic “vibration sensor” is extracted from the diagnosis model storage part 12, the use frequency regarding the coupling relationship of the diagnosis module “sliding window start” and “window function” is calculated, and then, when the use frequency exceeds the preset threshold, it is determined that the reusability is high. The processing in steps 34 and 35 are repeated until the reusability of the coupling relationship in which a new diagnosis module is added falls below a predetermined threshold.

When it is determined in step 34 that the reusability of the new coupling relationship is low, the diagnosis model component search device 15 stores the coupling relationship, the reusability of which was determined to be high in previous step 34, into the diagnosis storage part 14 as a diagnosis model component (step 36).

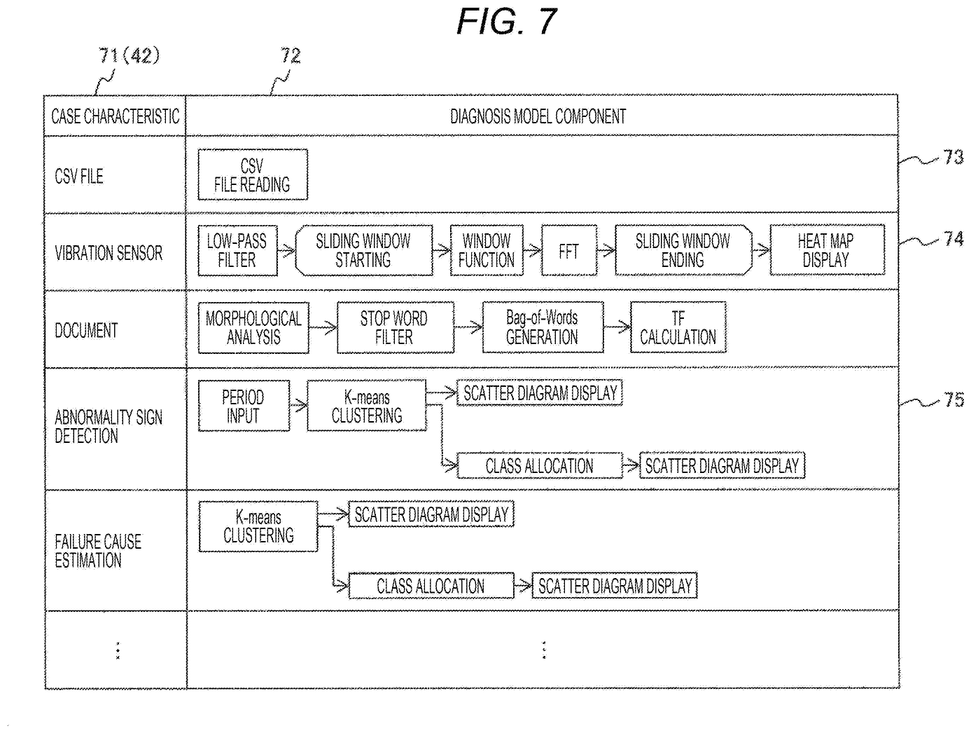

FIG. 7 is an example of the diagnosis model component table registered in the diagnosis model component storage part 14 as a result of the processing from step 31 to step 36. In this table, a case characteristic field 71 is a field for storing the same contents as those of the case characteristic field 42, and the diagnosis model component field 72 is a field for storing the diagnosis model components extracted by the diagnosis model component search device 15 for each case characteristic of the case characteristic field 71. In FIG. 7, for example, the coupling relationship of the diagnosis modules in the sequence of “low pass filter,” “sliding window start,” “window function,” “FFT,” “sliding window ending,” and “heat map display” for the case characteristic “vibration sensor” is registered as a diagnosis model component (record 73).

Returning to FIG. 3, processing after step 36 will be described. After extracting the diagnosis model components for the first diagnosis module of the first case characteristic, the diagnosis model component search device confirms whether there remain diagnosis modules not subjected to the processing of steps 34 to 36 among the diagnosis modules narrowed down in step 32 (step 37). When unprocessed diagnosis modules remain, a diagnosis model component is extracted for each of those diagnosis modules (steps 34 to 36).

Further, the diagnosis model component search device 15 confirms whether there remain case characteristics not subjected to the processing of steps 33 to 37 among the case characteristics stored in the case characteristic storage part 11 (step 38). When unprocessed case characteristics remain, a diagnosis model component is also extracted from each of those case characteristics (steps 33 to 37).

The above processing is repeated, and when the extraction of the diagnosis model components has been completed for all the case characteristics and all the diagnosis modules, the diagnosis model component generation processing illustrated in FIG. 3 ends.

<“Search/Presentation” Processing>

Subsequently, the “search/presentation” processing, which is a second phase of the operation of the diagnosis model component reuse support apparatus 10, will be described.

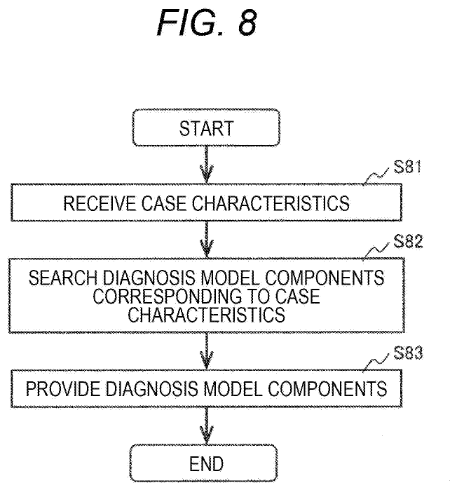

FIG. 8 is a flowchart illustrating search/presentation processing executed by the diagnosis model component reuse support apparatus 10. This processing is started by the diagnosis model component reuse support apparatus 10 receiving the execution of the search/presentation processing from the user. In the following, the processing of FIG. 8 will be described taking as an example a case where a new diagnosis model for detecting an abnormality sign of the equipment to be diagnosed is developed based on signal data collected by a vibration sensor of the equipment to be diagnosed.

When the diagnosis model component search/presentation processing is started, the diagnosis model component search device 15 receives inputs of case characteristics of a diagnosis model developed by the user (step 81).

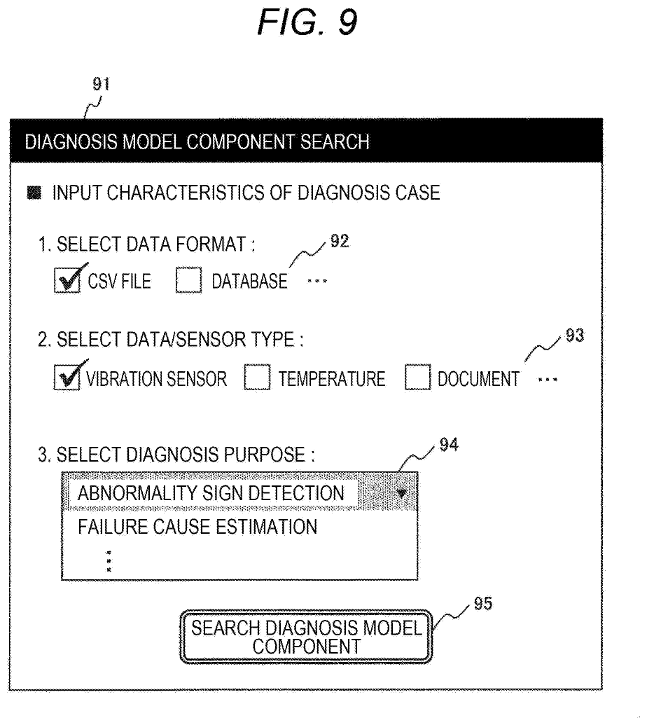

FIG. 9 is an example of a screen for receiving inputs of case characteristics. As illustrated here, input items 92 relating to the data format, input items 93 relating to the data/sensor type, and input items 94 relating to the diagnosis purpose are displayed on a case characteristic input screen 91. For example, when the case characteristic table of FIG. 4 is reflected in the case characteristic input screen 91, the case characteristics of the “data format” category, such as “CSV file” and “database,” are displayed in the input items 92, the case characteristics of the “data/sensor type” category, such as “vibration sensor,” “temperature,” and “document,” are displayed in the input item 93, and the case characteristics of the “diagnosis purpose” category, such as “abnormality sign detection” and “failure cause estimation,” are displayed in the input items 94.

When such an input screen is displayed and the signal data of the vibration sensor installed in the equipment to be diagnosed is output as a comma separated values (CSV) file, the user inputs “CSV file” as the input item 92, “vibration sensor” as the input item 93, and “abnormality sign detection” as the input item 94. Then, after selecting all of these, the search button 95 is pressed to complete the input of the case characteristics.

Thereafter, the diagnosis model component search device 15 searches diagnosis model components corresponding to the input case characteristics (step 82). For example, for the case characteristic “CSV file” input in step 81, the diagnosis model component table in FIG. 7 is checked, and the diagnosis model component “CSV file reading” in record 73 is extracted. Similarly, for the respective case characteristics “vibration sensor” and “abnormality sign detection,” the diagnosis model components registered in record 74 and record 75 are extracted. That is, as a result of the search in step 82, record 73 to record 75 corresponding to the input case characteristics are extracted.

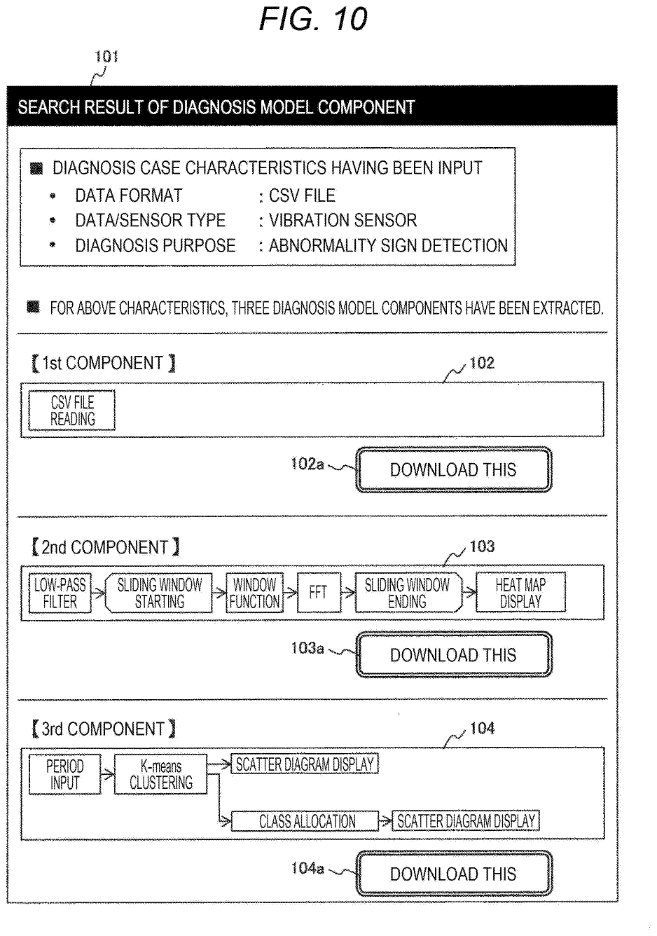

Subsequently, the diagnosis model component search device 15 presents the diagnosis model components searched in step 82 to the user (step 83). FIG. 10 is a diagram illustrating an example of a screen on which the diagnosis model component reuse support apparatus 10 presents diagnosis model components to a user, and as illustrated here, a diagnosis model component presentation screen 101 displays three diagnosis model components extracted in step 82, which are a diagnosis model component 102 of record 73, a diagnosis model component 103 of record 74, and a diagnosis model component 104 of record 75.

The diagnosis model component presentation screen 101 displays download buttons 102a, 103a, 104a for the respective diagnosis model components, and the user can press a desired download button to obtain a desired diagnosis model component.

By forming the configuration of the present embodiment described above, it is possible to extract an appropriate diagnosis model component for the user based on case characteristics of a new diagnosis model developed by the user and present the extracted diagnosis model to the user. This makes it possible to easily extract knowledge included in diagnosis models developed by skilled designers in the past, so that even when a less skilled designer develops a new diagnosis model, the quality of the diagnosis model can be enhanced easily.

Note that the present invention is not limited to the embodiments described above, but includes various modifications. For example, the above embodiments have been described in detail for easy understanding of the present invention, and the present invention is not necessarily limited to having all the configurations described. A part of the configuration of a certain embodiment can be replaced with the configuration of another embodiment, and the configuration of another embodiment can be added to the configuration of a certain embodiment. It is possible to add, delete, and replace other configurations for a part of the configuration of each embodiment. Each of the above configurations, functions, processing units, processing means, and the like may be partially or entirely achieved by hardware by, for example, designing an integrated circuit. Each of the above configurations, functions, and the like may be achieved by software by a processor interpreting and executing a program that achieves each function. Information such as a program, a table, and a file for achieving each function can be stored in a recording device such as a memory, a hard disk, or a solid-state drive (SSD), or a recording medium such as an integrated circuit (IC) card, a secure digital (SD) card, or a digital versatile disc (DVD).

### REFERENCE SIGNS LIST

10 diagnosis model component reuse support apparatus
11 case characteristic storage part
12 diagnosis model storage part
13 diagnosis module storage part
14 diagnosis model component storage part
15 diagnosis model component search device
15a reusability calculator
15b coupling relationship extension part
16 search condition input part
17 display
20 information processing device
21 CPU
22 ROM
23 RAM
24 input/output interface

1. A diagnosis model component reuse support apparatus comprising:
a case characteristic storage part that stores case characteristics of a past diagnosis case;
a diagnosis model storage part that stores a diagnosis model of the past diagnosis case;
a diagnosis module storage part that stores diagnosis modules constituting the diagnosis model; and
an operational device that supports reuse of a diagnosis model component of the past diagnosis case when a diagnosis model for a new diagnosis case is constructed,
wherein
the operational device includes
a reusability calculator that, by using the case characteristics in the case characteristic storage part, the diagnosis model in the diagnosis model storage part, and the diagnosis modules in the diagnosis module storage part, calculates, for each of the case characteristics, reusability of each of the diagnosis modules or reusability of a coupling relationship of the diagnosis modules, and extracts a diagnosis module or a coupling relationship having high reusability as a diagnosis model component, and
a coupling relationship extension part that extends the coupling relationship by adding another diagnosis module to the diagnosis model component.

2. The diagnosis model component reuse support apparatus according to claim 1, wherein the reusability calculator calculates reusability of a coupling relationship obtained by the coupling relationship extension part adding another diagnosis module to the diagnosis module or the coupling relationship.

3. The diagnosis model component reuse support apparatus according to claim 2,
wherein
the reusability calculator selects the coupling relationship after the addition of another diagnosis module as a diagnosis model component when the reusability of the coupling relationship obtained by the addition of another diagnosis module is high, and
the reusability calculator selects the coupling relationship before the addition of another diagnosis module as a diagnosis model component when the reusability of the coupling relationship obtained by the addition of another diagnosis module is low.

4. The diagnosis model component reuse support apparatus according to claim 2, wherein the case characteristics are characteristics including at least one of a data format, a data/sensor type, and a diagnosis purpose of a diagnosis case.

5. The diagnosis model component reuse support apparatus according to claim 1, wherein the reusability calculator calculates the reusability in accordance with use frequency of the diagnosis module or the coupling relationship.

6. The diagnosis model component reuse support apparatus according to claim 1, wherein the reusability calculator calculates the reusability by using Bayesian inference.

7. The diagnosis model component reuse support apparatus according to claim 1, further comprising
a display that, when a user inputs a case characteristic of a new diagnosis case, displays the diagnosis model component extracted by the reusability calculator with respect to the case characteristic.

8. A diagnosis model component reuse support method of, with use of case characteristics of a past diagnosis case, a diagnosis model of the past diagnosis case, and diagnosis modules each being a unit of processing of the diagnosis model, supporting reuse of a diagnosis model component of the past diagnosis case when a diagnosis model of a new diagnosis case is constructed, the method comprising:
calculating, by using the past case characteristics, the past diagnosis model, and the past diagnosis modules, reusability of each of the diagnosis modules or reusability of a coupling relationship of the diagnosis modules for each of the case characteristics, and extracting a diagnosis module or a coupling relationship having high reusability as a diagnosis model component; and
subsequently extending the coupling relationship by adding another diagnosis module to the diagnosis model component.
